(19) United States
(12) Patent Application Publication
(10) Pub. No.: US 2019/0222806 A1
(43) Pub. Date: Jul. 18, 2019

(54) COMMUNICATION SYSTEM AND METHOD

(71) Applicant: 2MEE Ltd, Yorkshire (GB)

(72) Inventors: David Soppelsa, Yorkshire (GB); Christopher George Knight, Yorkshire (GB); James Patrick Riley, Yorkshire (GB); Gerrard Allen, Yorkshire (GB)

(21) Appl. No.: 15/578,287

(22) PCT Filed: Oct. 31, 2016
(86) PCT No.: PCT/GB2016/053373

§ 371 Date: Nov. 30, 2017

(30) Foreign Application Priority Data
Oct. 30, 2015 (GB) 1519179.4
Nov. 25, 2015 (GB) 1520793.9

(51) Int. Cl. H04N 7/15; H04L 12/58; H04L 12/18; H04N 5/262; H04N 5/272

(52) U.S. Cl. CPC H04N 7/155; H04L 51/10; H04N 7/157; H04N 5/2621; H04N 5/272; H04L 12/1822

(57) ABSTRACT

A messaging system comprises a plurality of devices wherein at least a first sending user device is arranged in use to transmit an image to at least a second receiving user device which image comprises an electronically captured image of at least a part of a head of the sender extracted from a background. FIG. 1, shows various images 100 on displays (110) as received by recipients. The method and apparatus described above allow something between a text message exchange and a video call. The message sender uses either the front camera or the rear camera in the device, typically a smart phone, to capture a short video of them speaking and the app software cuts out the sender's head 100 from any background before transmitting the video clip to appear on the recipient's screen (110). The cut-out head can appear on a recipient's desktop, conveniently as part of a messaging screen. Alternatively the recipient, who also has the app, can open the rear-facing camera of their phone so that the head appears to float in their environment (112) as it plays the short performance. The process is reversed to make a reply.

The present invention relates to a communication system and to a method of communication, and is concerned particularly, although not exclusively, with a messaging system and a method of messaging.

Presently, there are various systems that, beyond conventional telephonic communication, allow messaging between people using electronic equipment, such as computers and smart phones. One such system is the Short Messaging Service (SMS), known more widely as “texting”, in which users can exchange short text messages across a mobile telecommunications network, according to a standardised protocol. The messages must be keyed into the device by the sender, and read by the recipient. Recently it has become possible to convert speech directly to text for sending an SMS message.

Other widely used communications systems involve sending text or images across the Internet between a sender and a recipient. Such systems can be used to send video recordings, and even real-time, or substantially real-time, moving images. However, because of the large file sizes this type of communication uses large amounts of bandwidth or else the moving images appear slow and disjointed to the users.

Augmented reality is a term used to describe, among other things, an experience in which the viewing of a real world environment is enhanced using computer generated input.

Augmented reality is increasingly becoming available across various types of hardware, including hand held devices such as cell phones.

The use of hand held devices, such as cell phones, as cameras has been enhanced by the availability of small, specialised downloadable programs, known informally as apps. Many of these include computer generated visual effects that can be combined with a “live view” through the camera, to provide the user with a degree of augmented reality for an improved image or amusement. However the incorporation of video footage into the live view of a camera has proved to be difficult due to the limited processing power available in most hand held devices, and the lack of a functional codebase provided with the built-in frameworks.

Our published UK patent application, GB 2 508 070 describes examples of techniques for generating effective augmented reality experiences on hand-held devices.

A further drawback with prior systems is that the recipient is only able to view the image, whether live or as a recording, in a video panel on his display. There is little scope for changing the appearance of the video image, such as by the use of augmented reality.

Embodiments of the present invention aim to provide a communication system in which at least some of the above drawbacks with the prior art are at least partially overcome.

The present invention is defined in the attached independent claims to which reference should now be made. Further, preferred features may be found in the sub-claims appended thereto.

According to an aspect of the present invention there is provided a messaging system comprising a plurality of devices wherein at least a first sending user device is arranged in use to transmit an image to at least a second receiving user device which image comprises an electronically captured image of at least a part of a head of the sender extracted from a background.

The image may be sent via a communications network, which may include a processor-based server.

Preferably the system is arranged in use to extract an image of at least a part of a head, and more preferably at least a part of a face, from a background. The image of the face preferably includes any hair on the head or face.

The image preferably comprises a moving video image. In a preferred arrangement the image is transmitted with audio content. Preferably the image is transmitted with an audio file containing a message from the sender. The audio file is preferably arranged to be synchronised with the moving image when the image is played back by the receiving device. Alternatively the audio content and video content may be integrated.

The sending user device may comprise any one or more of the following, but not limited to: a smartphone, a tablet, a watch, a computer, a television.

The receiving user device may comprise any one or more of the following, but not limited to: a smartphone, a tablet, a watch, a computer, a television.

The messaging system may be arranged in use to send a first moving image from a first sender to a first receiver and to send a second moving image from a second sender to a second receiver. The first sender may comprise the send receiver. The second sender may comprise the first receiver.

The messaging system may be arranged for the exchange of video and/or audio content between plural users. The content may be exchanged substantially synchronously, concurrently, contemporaneously, simultaneously and/or in real time.

Alternatively, content may be exchanged substantially asynchronously, non-simultaneously, non-contemporaneously and/or not in real time.

A substantially real-time exchange may allow a video discussion to take place between multiple users.

Where two or more users exchange content the system may be arranged to display an image of the users on the same screen. This can be used for a group chat of for group messaging.

In a preferred arrangement the system provides that the image of a user who is currently speaking, and/or from whom the most recent content has been received, is indicated as such. The indication may comprise a highlighting of the user's image, or enlarging or otherwise modifying of it.

In a preferred arrangement the system allows a user to select another user with whom to communicate by touching an image of the selected user presented on a display of the device.

The system may comprise a converter to convert audio (voice) to text and/or text to audio (voice).

The system may be arranged to display one or more contacts as images.

The system may include a login and/or logout process comprising a facial recognition unit arranged to determine the identity of an authorised user of the system, according to previously stored facial image data, which may include biometric data.

The system may be arranged in use to provide an augmented reality image, the system comprising a camera for recording a basic image comprising a subject and a first background using a recording device, an image processor for extracting a subject image from the basic image, and a display device for combining the extracted subject image with a second background, wherein the subject image comprises at least a part of a head.

Preferably the extracted subject image is arranged in use to be combined with the second background as imaged by a camera of the display device.

In one embodiment the recording device and the display device are parts of a common device, which may be a hand-held device. Alternatively or in addition the recording device and the display device may be separate and may be located remotely. The recording device and display device may each be part of separate devices, of which one or both may be a hand held device.

In a preferred arrangement the first and second backgrounds are temporally and/or spatially separate. The first background may comprise an image that is contemporaneous with the subject image and the second background may comprise an image that is not contemporaneous with the subject image.

The processor may be arranged in use to extract the subject from the basic image locally with respect to the recording device, and preferably within the device. Alternatively, the processor may be arranged in use to extract the subject image from the basic image remotely from the recording device.

The processor may be arranged in use to extract the subject image from the basic image in real time, with respect to the recording of the basic image. Alternatively, the processor may be arranged in use to perform the extraction after the recording of the basic image.

The subject image may comprise one that has been previously stored.

The subject image may comprise a sequence of still images taken from a moving video.

Alternatively or additionally the subject image may comprise a continuous moving video image.

For viewing the image, a context identification unit may be arranged in use to identify a context for the subject image. This may be achieved by comparing at least one object in a field of view with stored data from a plurality of objects. An image retrieval unit may be arranged to select an image from a plurality of stored images according to context information determined by the context identification unit. A positioning unit may be arranged in use to position the subject image in a background. This may be achieved according to context information determined by the context identification unit.

The positioning of the subject image by the positioning unit may include sizing of the subject image in the display, and may include anchoring the subject image in the display, preferably with respect to context information determined by the context identification unit.

The context identification unit, and/or the retrieval unit, and/or the positioning unit may comprise processes arranged in use to be performed by one or more electronic processing devices.

The invention also provides a method of messaging between a plurality of devices, wherein at least a first, sending user is arranged in use to transmit an image to at least a second, receiving user which image comprises an electronically captured image of at least a part of a head of the sender extracted from a background.

The image may be sent via a communications network including a processor-based server.

Preferably the method comprises extracting an image of at least a part of a head, and more preferably at least a part of a face, from a background. The image of the face preferably includes any hair on the head.

The image preferably comprises a moving video image. In a preferred arrangement the method comprises transmitting the image with audio content. Preferably the method comprises transmitting the image with an audio file containing a message from the sender. The audio file is preferably arranged to be synchronised with the moving image when the image is played back by the receiving device. Alternatively the audio content and video content may be integrated.

The method preferably comprises sending a message using any one or more of the following, but not limited to: a smartphone, a tablet, a watch, a computer, a television.

The method preferably comprises receiving a message using any one or more of the following, but not limited to: a smartphone, a tablet, a watch, a computer, a television.

In a preferred arrangement the method comprises sending a first moving image from a first sender to a first receiver and sending a second moving image from a second sender to a second receiver. The first sender may comprise the send receiver. The second sender may comprise the first receiver.

The messaging method may comprise exchanging video and/or audio content between plural users. The content may be exchanged substantially synchronously, concurrently, contemporaneously, simultaneously and/or in real time.

Alternatively, content may be exchanged substantially asynchronously, non-simultaneously, non-contemporaneously and/or not in real time.

A substantially real-time exchange may allow a video discussion to take place between multiple users.

Where two or more users exchange content the method may comprise displaying images of the users on the same screen. This can be used for a group chat of for group messaging.

In a preferred arrangement the method comprises indicating the image of a user who is currently speaking, and/or from whom the most recent content has been received. The indication may comprise a highlighting of the user's image, or enlarging or otherwise modifying of it.

The method may comprise selecting another user with whom to communicate by touching an image of the selected user presented on a display of the device.

The method may comprise converting audio (voice) to text and/or text to audio (voice).

The method may comprise displaying one or more contacts as images. The displayed images of contacts may comprise recorded moving images. In a preferred arrangement the displayed images of contacts may comprise a clip of a moving video image which may be arranged to play in a loop, and may be arranged to reverse the moving video image at the end of the clip.

The method may include determining the identity of an authorised user of the system using a login and/or logout process comprising facial recognition, by reference to a previously stored image.

The method may include providing an augmented reality image, by recording a basic image comprising at least a part of a head and a first background using a recording device, extracting a subject image comprising the at least part of the head from the basic image, and providing the extracted subject image to a display device for combining with a second background.

The second background may comprise any of, but not limited to: a desktop background, e.g. a display screen of a device, a background provided by an application or a background captured by a camera. The background may be captured by a camera of a device on which the subject image is to be viewed.

Preferably the extracted subject image is provided to the display device for combining with a second background as imaged by a camera of the display device.

In one embodiment the recording device and the display device are parts of a common device, which may be a hand-held device. Alternatively or in addition the recording device and the display device may be separate and may be located remotely. The recording device and display device may each be part of separate devices, which devices may be hand-held devices and which devices may comprise, but are not limited to, mobile telephones and tablets.

The recording and display devices may comprise different types of device.

In a preferred arrangement the first and second backgrounds are temporally and/or spatially separate. The first background may comprise an image that is contemporaneous with the subject image and the second background may comprise an image that is not contemporaneous with the subject image.

In a preferred arrangement the step of extracting the subject from the basic image is performed locally with respect to the recording device, and preferably within the device. Alternatively, the step of extracting the subject image from the basic image may be performed remotely from the recording device.

The step of extracting the subject image from the basic image may be performed in real time, with respect to the recording of the basic image, or else may be performed after recording of the basic image.

Preferably the method comprises sending the extracted subject image from one device to another device. The image is preferably a moving image, and more preferably a moving, real-world image.

The extracted subject image may comprise a head and/or face of a user, such as of a sender of the image. The image is more preferably a moving image and may include, be attached to, or be associated with, an audio file, such as a sound recording of, or belonging to, the moving image.

The image may include one or more graphical elements, for example an augmented reality image component. The augmented reality image component may be anchored to the extracted subject image so as to give the appearance of being a real or original element of the extracted subject image.

In a preferred arrangement the method includes sending an extracted subject image, preferably a moving image, over a network to a recipient for viewing in a recipient device. Optionally a sound recording may be sent with the extracted subject image. Alternatively, or additionally, the method may include sending the extracted subject image directly to a recipient device.

In a preferred arrangement, the method comprises recording a basic image comprising a subject and a first background, extracting a subject from the background as a subject image, sending the subject image to a remote device and combining the subject image with a second background at the remote device.

The method may include extracting a subject from a basic image by using one or more of the following processes:

subject feature detection, subject colour modelling and subject shape detection.

According to another aspect of the present invention, there is provided electronic apparatus for automatically determining the perimeter of a face or head with hair in an electronically captured image, the apparatus comprising a facial detection unit and a perimeter detection unit, wherein in use the facial detection unit is arranged to detect a face, and the perimeter detection unit is arranged to determine a forehead, based upon the position of recognised facial features, and then to identify an edge region on the forehead, indicative of hair, based upon a colour change.

The perimeter detection unit may be arranged to assign a hair colour (C) based upon the pixel colour beyond the edge region. Preferably the perimeter detection unit is arranged in use to determine an area (A) around the face and search for regions (R) within the area (A) that have a colour value within a predetermined threshold range of the colour (C).

Preferably the apparatus is arranged to substantially merge together the said regions (R) to display as hair in the image.

Preferably the apparatus is arranged in use to update the colour value of (C) by averaging the value across multiple frames of a moving video image.

The invention also includes a method of automatically determining the perimeter of a face with hair in an electronically captured image, the method comprising detecting a face, determining a forehead, based upon the position of recognised facial features and identifying an edge region on the forehead, indicative of hair, based upon a colour change.

The method may comprise assigning a hair colour (C) based upon the pixel colour beyond the edge region. Preferably the method comprises determining an area (A) around the face and searching for regions (R) within the area (A) that have a colour value within a predetermined threshold of the colour (C).

The method may comprise merging together the said regions (R) to display as hair in the image.

Preferably the method comprises updating the colour value of (C) by averaging the value across multiple frames of a moving video image.

According to another aspect of the present invention, there is provided apparatus for determining a user reaction to media content delivered to the user on a device comprising a camera, the apparatus being arranged in use to play the content and to monitor an image of the user's face, wherein a processor is arranged to determine the user's reaction to the content by analysis of the image.

The image is preferably a moving image. The processor may be arranged to compare the image with one or more stored reference images.

In a preferred arrangement, the apparatus is arranged to determine whether the user has a positive reaction to the content. The apparatus may be arranged to determine whether the user has a negative reaction to the content. The apparatus may be arranged to determine whether the user's reaction to the content is neither positive nor negative.

The camera may be arranged to capture an image of the user covertly.

Alternatively or in addition, the camera may be arranged to capture an image of the user overtly.

In a preferred arrangement, the image comprises an image of the face of the user, which facial image may be extracted from a background.

The apparatus may be arranged to monitor other response indicia from the user, including one or more of (but not limited to): temperature change, heart rate/pulse, perspiration level change, blood-pressure change and pupil dilation.

By monitoring the image of the user's face, and/or capturing one or more of the other response indicia, a user's level of interest or excitement in the content may be determined. The interest level may be determined within an index or range of levels, and need not be a binary value.

The invention also provides a method of determining a user reaction to media content delivered to the user on a device including a camera, the method comprising playing the content on the device, enabling a camera of the device to capture an image of the user's face and analysing the image to determine the user's reaction to the content.

The content may comprise audio and/or video content and may be live or pre-recorded. The content may comprise augmented reality content.

In accordance with yet another aspect of the present invention, there is provided apparatus for user interaction with content delivered to the user on a device comprising a display, wherein the apparatus is arranged in use to play a first portion of content on the display and to capture an instruction and/or a reaction from the user, wherein a processor is arranged to select and play at least a subsequent portion of content on the display based upon the instruction and/or reaction from the user.

The further content may be selected from a library of further content.

In a preferred arrangement, at least the first portion of content comprises a moving image of a face, which image is preferably extracted from a background.

The invention also includes a method of interacting with media content delivered to a user, the method comprising providing at least a first portion of content on a display of a user's device, capturing audio and/or visual instruction and/or reaction from a user in response to the content, and selecting further content for display to the user based upon the captured instruction, from a library of further content items.

In a preferred arrangement, at least the first portion of content comprises a moving image of a face, preferably extracted from a background.

According to another aspect of the present invention, there is provided a method of encoding a video image, the method comprising recording a video image comprising a subject portion and a background portion, detecting the subject portion and extracting it from the background portion, generating a mask corresponding to the outline of the subject portion, and ascribing a first alpha value to the region within the outline and a second alpha value to the region outside the outline, the method further comprising pairing frames of the video image in which one of the pair comprises the subject against a background that is blurred, and the other of the pair comprises the mask.

The invention also comprises a video encoding device, arranged in use to record a video image comprising a subject portion and a background portion, detect the subject portion and extract it from the background portion, generate a mask corresponding to the outline of the subject portion, and ascribe a first alpha value to the region within the outline and a second alpha value to the region outside the outline, wherein the device is further arranged in use to pair frames of the video image in which one of the pair comprises the subject against a background that is blurred, and the other of the pair comprises the mask.

Preferably the first alpha value is significantly larger than the second alpha value, so that the region of the mask outside the outline appears as a dark, more preferably black, background.

The invention also provides a program for causing a device to perform a method according to any statement herein.

The program may be contained within an app. The app may also contain data, such as subject image data and/or background image data.

The invention also provides a computer program product, storing, carrying or transmitting thereon or therethrough a program for causing a device to perform a method according to any statement herein.

The invention may include any combination of the features or limitations described herein, except such a combination of features as are mutually exclusive.

Preferred embodiments of the present invention will now be described by way of example only with reference to the accompanying diagrammatic drawings in which:

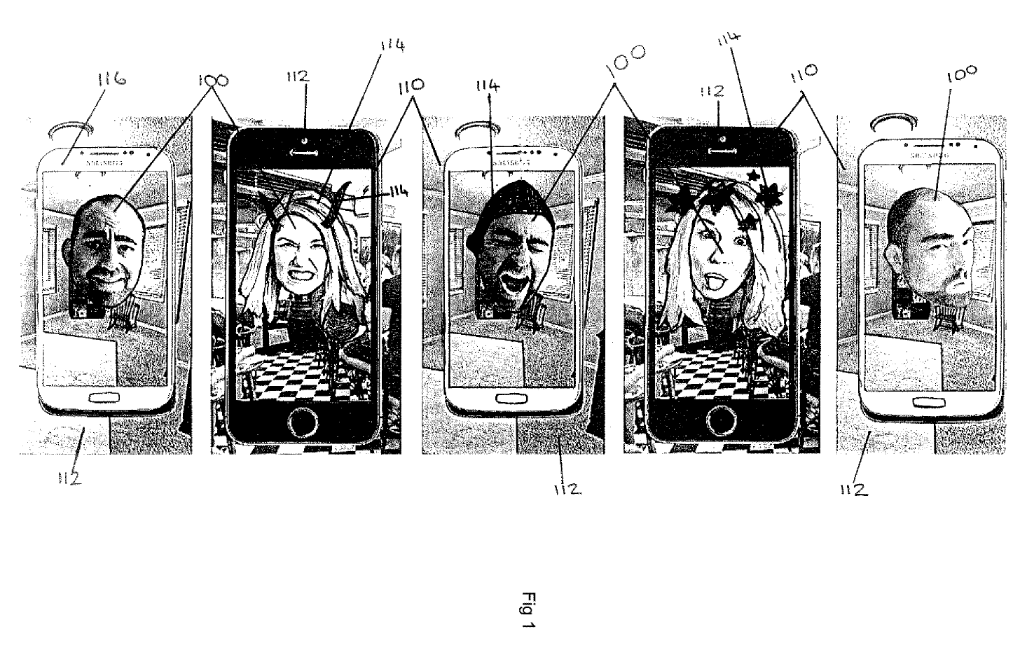

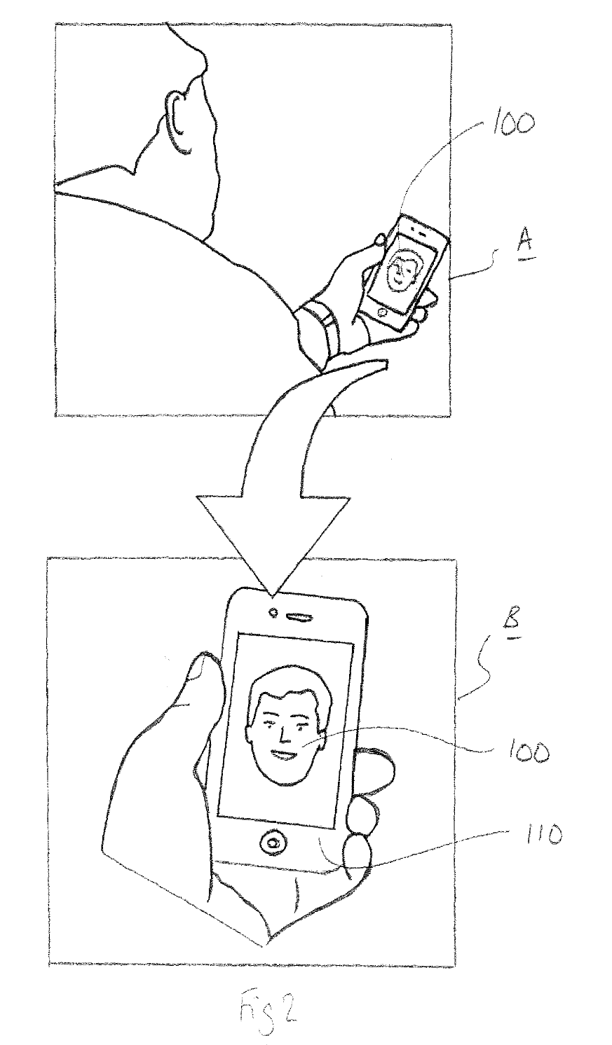

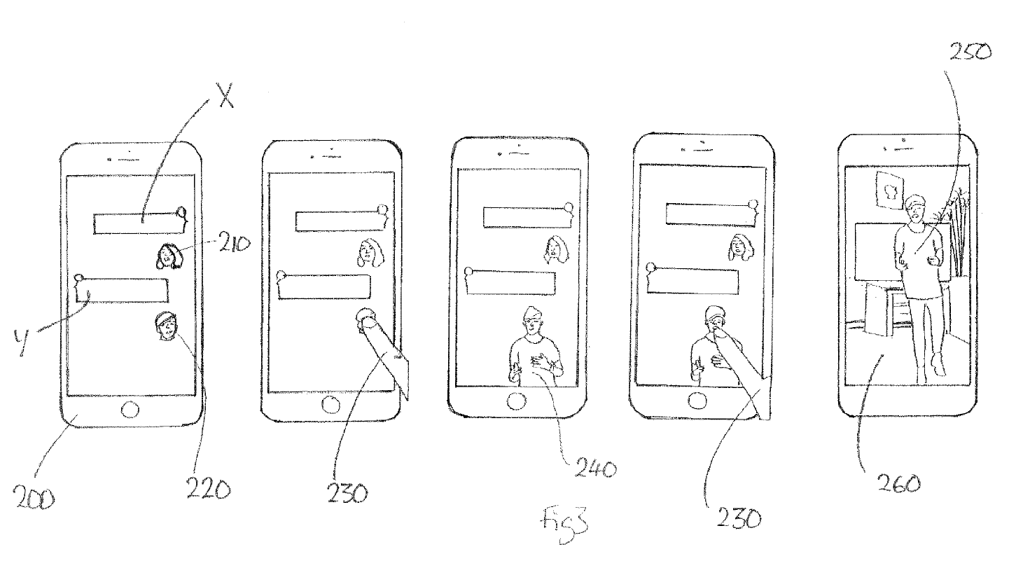

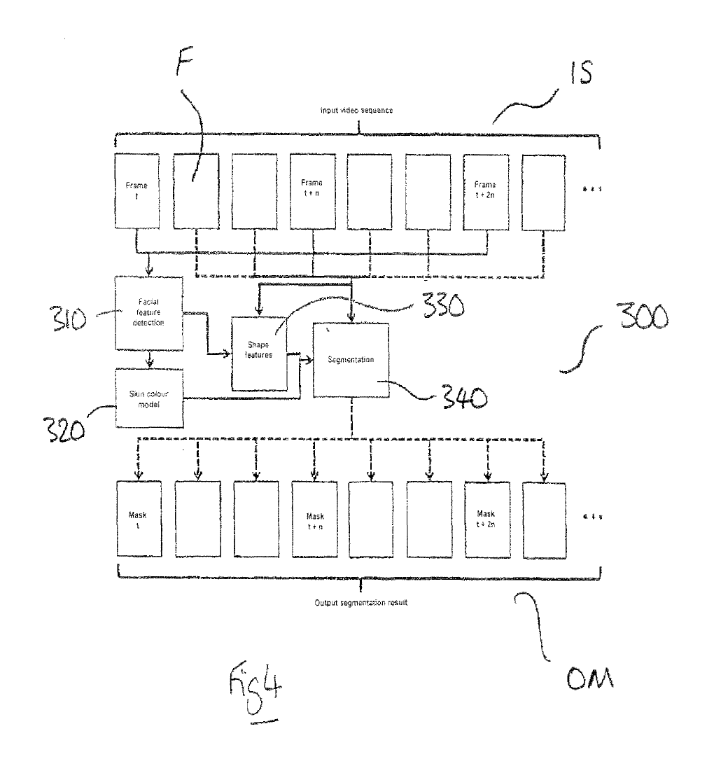

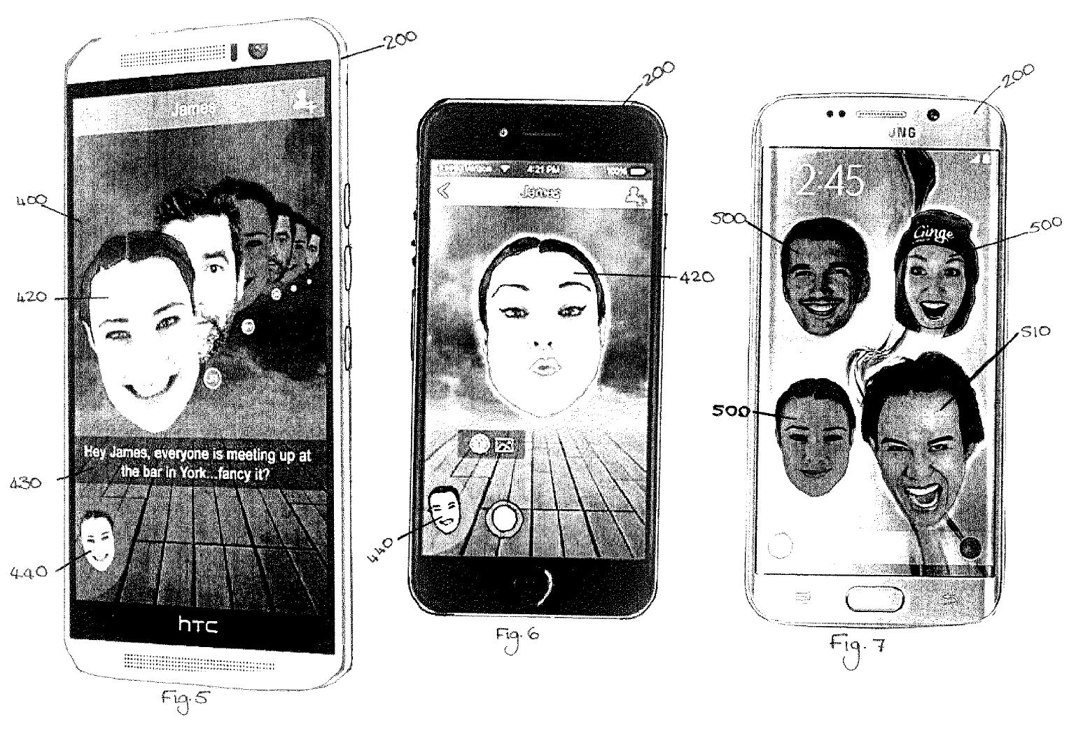

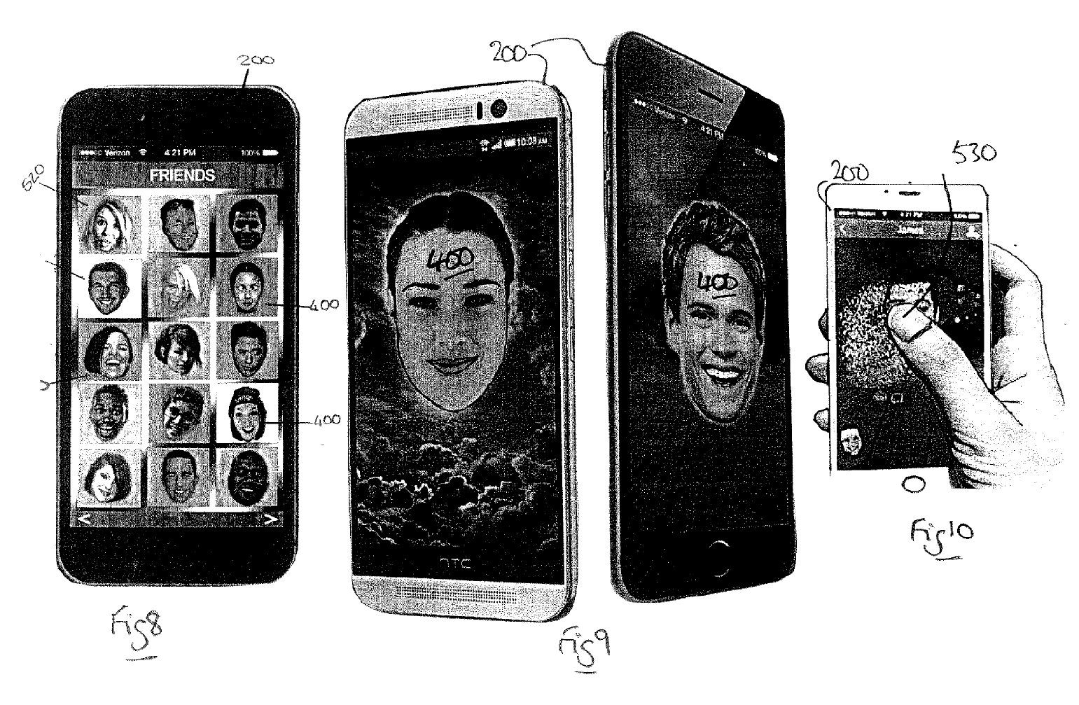

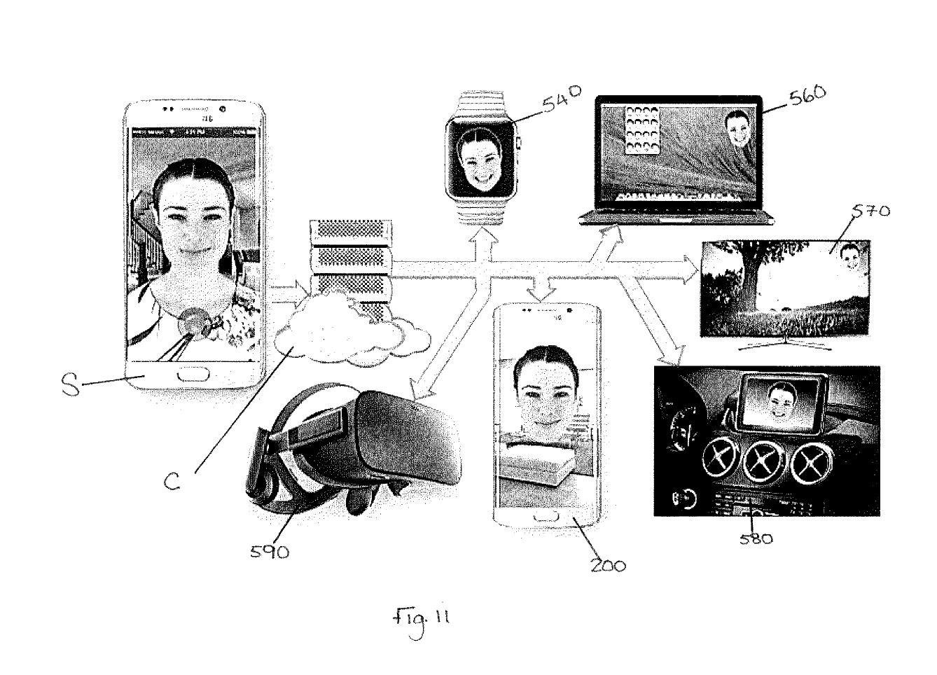

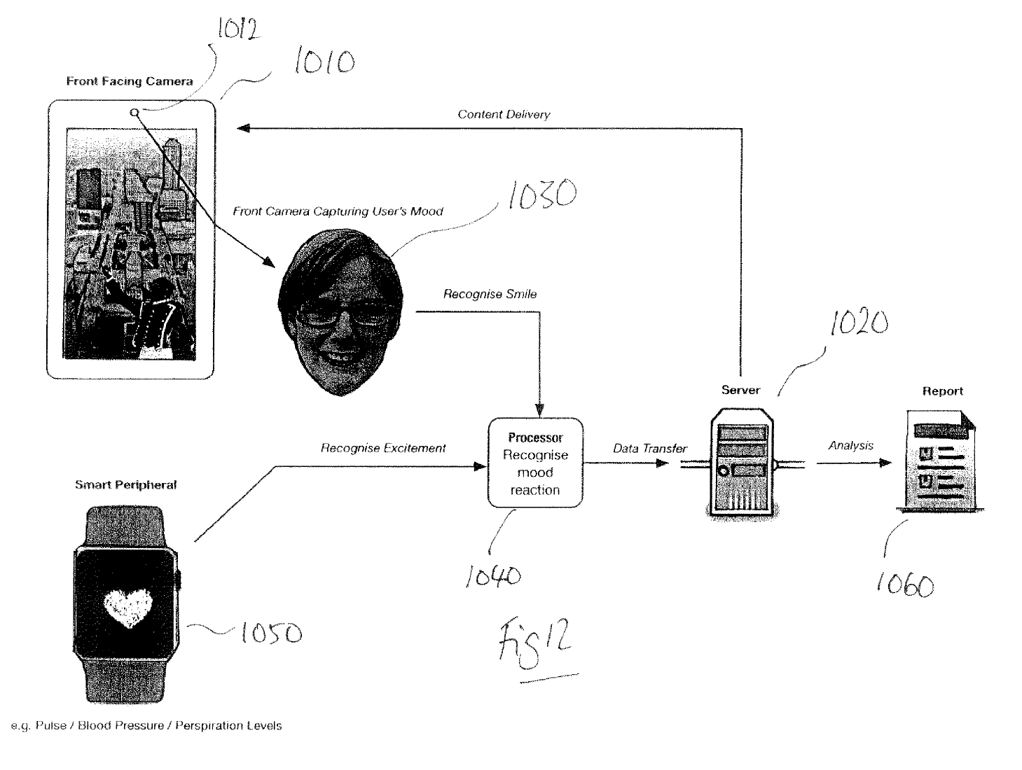

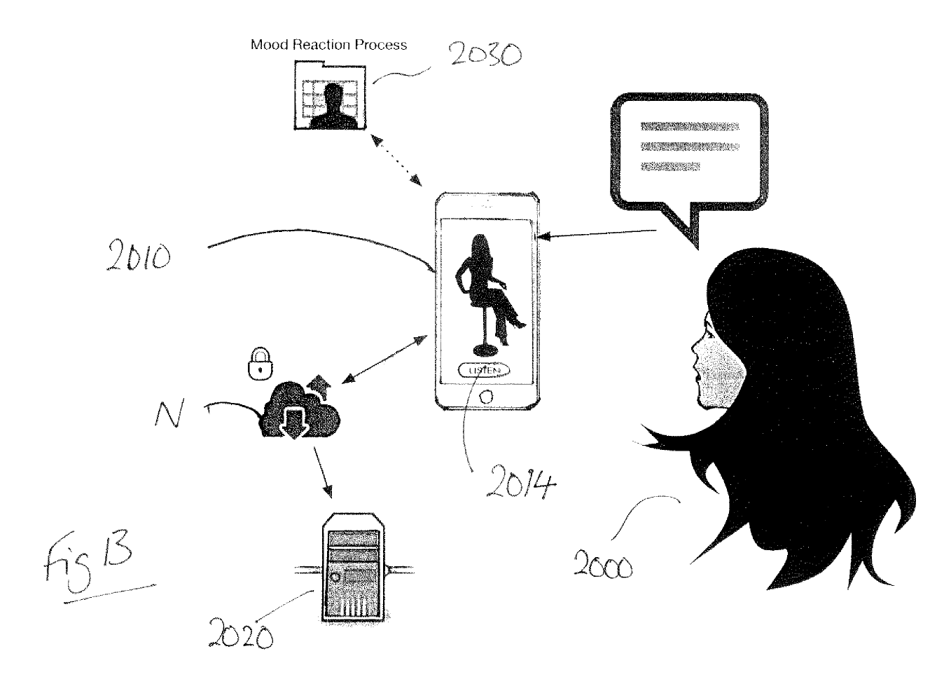

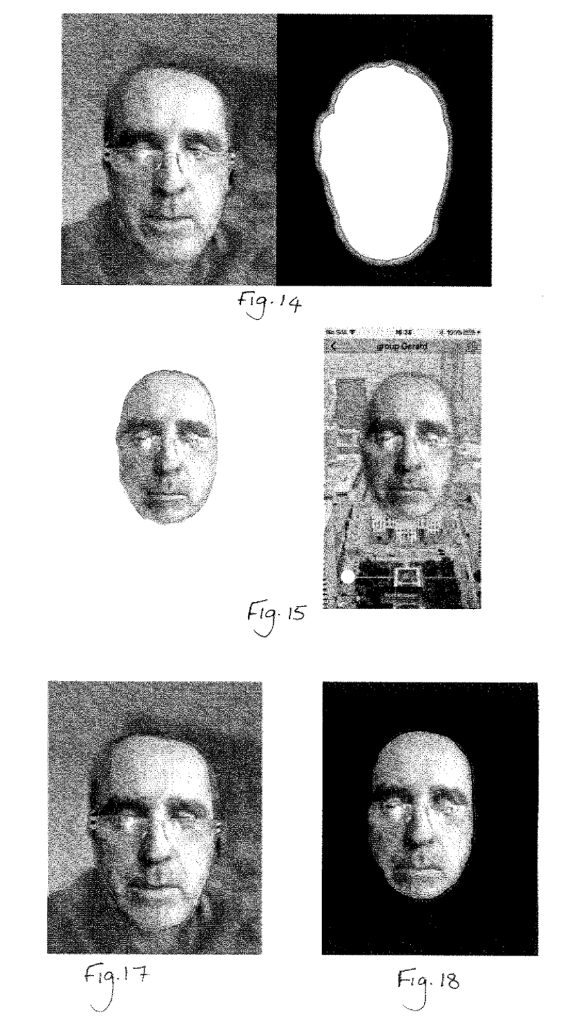

FIG. 1 shows examples of extracted images of heads displayed on screens, in accordance with an embodiment of the present invention;

FIG. 2 shows schematically a method of recording a message;

FIG. 3 shows schematically a process of sending a message in accordance with an embodiment of the present invention;

FIG. 4 shows schematically some of the processes used in extraction of a subject image from a basic image including the subject and a background;

FIG. 5 shows a screen of a hand held device on which a messaging system according to an embodiment of the present invention is implemented;

FIG. 6 shows another screen in which a received message is played;

FIG. 7 depicts a screen in a group video call;

FIG. 8 shows a contacts screen;

FIG. 9 shows both screens in a conversation between two users;

FIG. 10 shows a user interacting with a screen at the end of a call;

FIG. 11 shows various types of device with which embodiments of the present invention may be used;

FIG. 12 shows schematically a system for detecting a user reaction to displayed content;

FIG. 13 shows a system for interacting with a displayed content;

FIGS. 14 to 17 show, schematically, steps in an image processing method, according to an embodiment of the present invention;

Embodiments of the present invention described below are concerned with a chat system or messaging platform in which a mobile phone is the device of choice. Users are able to send short video clips of themselves delivering a message audibly and/or in text form. Only the head is sent as an image, extracted from the background by a method as described below.

Turning to FIG. 1, this shows various images 100 on displays 110 as received by recipients. The method and apparatus described above allow something between a text message exchange and a video call. The message sender uses either the front camera or the rear camera in the device, typically a smart phone, to capture a short video of them speaking and the app software cuts out the sender's head 100 from any background before transmitting the video clip to appear on the recipient's screen 110. The cut-out head can appear on a recipient's desktop, conveniently as part of a messaging screen. Alternatively the recipient, who also has the app, can open the rear-facing camera of their phone so that the head appears to float in their environment 112 as it plays the short performance. The process is reversed to make a reply.

FIG. 2 shows the process schematically. At A the sending person uses the app to record a moving image of their own head—ie a video—which is separated from the background by the app. In a preferred arrangement the background can be automatically discarded substantially in real time.

However the person who makes the recording could instead manually remove the background as an alternative, or additional, feature. The image is then sent to a recipient who, at B, sees the head speak to them either on their desktop or in the camera view of the smart phone/tablet if they so choose.

Such a message according to the embodiment is different to a text message because:
It is faster to use than tapping out character keys
It conveys emotion as the facial expression can be seen and tone of voice heard, rather than just words on a screen v It can be both funny and personal
The users can take/store photos of the head, if the sender grants permission.

The message is different to a video call because:
It uses smaller amounts of the mobile user's data allowance.
It delivers discreet, individual ‘sound-bites’ of message
It has the option to add on augmented reality images, locked to the head, such as those shown at 114, including horns, a hat and stars, in the examples shown.
It can easily be kept for future reference
No background information is transmitted, only the head.

Hence the location of the creator can be kept private.

With embodiments of the present invention as described herein, images, including moving or video images, can be sent by a sender to a receiver to appear in the receiver's environment as a virtual image when viewed through a display of the receiver's device, against a receiver's background being imaged by a camera of the receiver's device. The image can be locked or anchored with respect to the background being viewed, so as to give the appearance of reality.

The images can comprise images created by the sender and extracted as a subject from a sender's background, to be viewed against a receiver's background. Furthermore, the images can be sent from user to user over a convenient messaging network.

It should be noted that with the methods described above, the sender is able to send an image of himself without revealing his background/whereabouts to the recipient.

The foreground, or subject, image can be sent without the background, and not merely with the background being made invisible (e.g. alpha value zeroed) but still remaining part of the image.

This has a number of important security benefits. In the first place, only the face can be transmitted as an image, ensuring that no inappropriate content is sent. Secondly, the face of the sender must appear, so that the sender cannot pretend to be someone else.

It should be noted that embodiments of the present invention employ techniques that identify the face (and hair) of the sender's image and remove this from the background. This contracts with some prior methods in which it is the background that is identified and removed.

Also, the examples above have the recipient viewing the received image through the camera view of the recipient's device, this need not be the case. For example, as an alternative the recipient may view the image floating on his desktop or above an app skin on his device. This may be more convenient to the user, depending on his location when viewing.

As the image to be sent comprises just a head of the sender, this represents a relatively small amount of data and so embodiments of the invention can provide a systemised approach to sending video images without the need for the usual steps of recording a video clip, saving, editing and then sending it to a recipient.

FIG. 3 shows a sequence of steps (from left to right) in a messaging process, in which a combination of the abovementioned options may be brought into the user experience. A hand held device 200 is used to convey messages in the form of speech bubbles between correspondent X and correspondent Y according to a known presentation. However, correspondent X also chooses to send to correspondent Y a moving image 210 of her own face, delivering a message.

In this example the conversation raises the subject of a performance by a musical artiste. One of the correspondents X and Y can choose to send to the other an image 220 of the artiste's head, which then appears on the desktop. The moving image can also speak a short introductory message.

This is available via the messaging app being run by the correspondents on their respective devices. If the head 220 is tapped with a finger 230, a fuller image 240 of the performer appears on top of the graphical features seen on the desktop to deliver a song, or other performance.

If the full image 240 is tapped by the finger 230 again it opens the camera (not shown) of the device so that a complete image 250 of the performer is integrated with a background image 260 of user's environment, in scale and anchored to a location within the background image so that it remains stationary with respect to the background if the camera move left/right or in/out to give the illusion of reality.

Thus, using the various aspects and/or embodiments of the invention described above, a user can switch between a cut-out part, such as a head, of a selected moving image, a fuller image and a complete augmented reality experience. Moreover this facility can be employed in a messaging system, between two or more correspondents.

The above described techniques can be used in other platforms, such as direct or peer-to-peer messaging platforms, in which a network need not be required. They can also be used for business, such as in business conferences, as well as for purely social interaction.

The above-described embodiments may also be used as part of a video voicemail system.

Furthermore, whilst in the above-described examples the users communicate using hand held devices such as mobile phones and/or tablet computers, the devices used need not be of the same type for both sender and receiver or for both/all correspondents in a messaging system. The type of device used may be any of a wide variety that has—or can connect to—a display. Gaming consoles or other gaming devices are examples of apparatus that may be used with one or more aspects of the present invention.

The process of extracting a subject from an image including an unwanted background is sometimes referred to as “segmentation”. The following description is of techniques for performing segmentation when the subject belongs to a known class of objects.

Method 4: Face Segmentation

When the source video comprises an object taken from a known object class, then object-specific methods for segmentation can be employed. In the following example human faces are to be segmented where the video is a spoken segment captured with the front facing camera (i.e. a “video selfie”). The same approach could be taken with any object class for which class-specific feature detectors can be built.

The face-specific pipeline comprises a number of process steps. The relationship between these steps is shown generally at 300 in the flowchart in FIG. 35. In order to improve the computational efficiency of the process, some of these steps need not be applied to every frame F (instead they are applied to every nth frame) of the input video sequence IS. A detailed description of each step is as follows:

In Process 310 facial feature detection is performed. The approximate location of the face and its internal features can be located using a feature detector trained to locate face features. Haar-like features are digital image features used in object recognition. For example, a cascade of Haar-like features can be used to compute a bounding box around the face. Then, within the face region the same strategy can be used to locate features such as the eye centres, nose tip and mouth centre.

In Process 320 skin colour modelling is performed. A parametric model is used to represent the range of likely skin colours for the face being analysed. The parameters are updated every nth frame in order to account for changing appearance due to pose and illumination changes. In the simplest implementation, the parameters can be simply the colour value obtained at locations fixed relative to the face features along with a threshold parameter. Observed colours within the threshold distance of the sampled colours are considered skin like.

A more complex approach is to fit a statistical model to a sample of skin pixels. For example, using the face feature locations, a set of pixels are selected that are likely to be within the face. After removing outliers, a normal distribution is fitted by computing the mean and variance of the sample. The probability of any colour lying within the skin colour distribution can then be evaluated.

In order to reduce the influence of colour variations caused by lighting effects, the model can be constructed in a colour space such as HSV or LCrCb. Using the H channel or the Cr and Cb channels, the model captures the underlying colour of the skin as opposed to its brightness.

At Process 330 shape features are determined. The skin colour model provides per-pixel classifications. Taken alone, these provide a noisy segmentation that is likely to include background regions or miss regions in the face. There are a number of shape features that can be used in combination with the skin colour classification. In the simplest implementation, a face template such as an oval is transformed according to the facial feature locations and only pixels within the template are considered. A slightly more sophisticated approach uses distance to features as a measure of face likelihood with larger distances being less likely to be part of the face (and hence requiring more confidence in the colour classification).

A more complex approach also considers edge features within the image. For example, an Active Shape Model could be fitted to the feature locations and edge features within the image. Alternatively, superpixels can be computed for the image. Superpixel boundaries naturally align with edges in the image. Hence, by performing classifications on each super-pixel as opposed to each pixel, we incorporate edge information into the classification. Moreover, since skin colour and shape classifiers can be aggregated within a superpixel, we improve robustness.

At process 340 Segmentation takes place. Finally, the output segmentation mask OM is computed. This labels each pixel with either a binary face/background label or an alpha mask encoding confidence that the pixel belongs to the face. The labelling combines the result of the skin colour classification and the shape features. In the implementation using superpixels, the labelling is done per-superpixel. This is done by summing the per-pixel labels within a superpixel and testing whether the sum is above a threshold.

Beauty/skin enhancement processes and/or filtering techniques, can be employed to alter the image of the face, for example to hide a blemish, during or after the recording stage. Computer generated imagery can also be added/overlaid as a filter or mask.

FIG. 5 shows a screen as a user would see it when a new message has arrived. Several “heads” 400 are depicted, representing recent messages, ranked in order of arrival, with the most recent one 420 on top. The user is able to scroll through the images—and hence the messages—in the manner of a carousel. The audio files of each of the messaged are stored. The audio file could be integral with the video content, or could be stored separately. Optionally the, or each, message or a part thereof, is shown in text beneath the image of the sender at 430. The audio to voice conversion is conducted by the app when the message is received. A smaller, still contact image 440 corresponding to the sender of the most recent message is displayed at the bottom of the screen

FIG. 6 shows a screen as a message is being viewed by a user. The sender's head 420 appears as a moving video image with a synchronised audio file. The sender's standard contact image is displayed at the bottom of the screen.

The embodiment shown in FIGS. 5 and 6 relate to asynchronous, or non-contemporaneous messages that are viewed not in real time.

However, embodiments of the present invention permit real-time, or substantially real-time, conversations with moving video images of faces, with synchronised audio content and/or text.

FIG. 7 shows a group video conversation in which five persons are engaged, with four being represented on the user's screen, the user being the fifth participant. The five faces 500 are spaced around the display of the hand held device 200, maximising the screen estate of the device. More or fewer participants may be accommodated. In order to make participation easier for the users, the system recognises which of the participants is currently speaking and indicates this. In the example shown, this is by enlarging the image 510 of the participant who is currently speaking.

A “live call” such as this can be achieved over the phone network—e.g. GMS, 3G, 4G—or via a specific server as a tunnel, or using a P2P (person-to-person) network or WebRTC protocols to ensure that the segmented head and face message is also a live call that may be delivered globally in the manner of a one-to-one, or one-to-many video call.

FIG. 8 shows a contact screen 520 on which the user's contacts are shown as extracted faces 400. To select a contact for the purpose of sending a message, or requesting a real-time conversation, the user may simply touch the individual contact image. Optionally, certain of the contact images may be arranged to be displayed as moving video images. A clip of video, recorded by the contact, for example upon registration with the app, may be played in a loop. The clip may be arranged to reverse at its end, so as to play as a seamless loop. Contacts from whom there are unopened messages may be arranged to be represented with the moving video images.

FIG. 9 shows a pair of hand held devices 200 as they appear to their users during a real-time conversation. With just one-to-one conversation substantially the entire screen area may be taken up by the image of the participant's face 400.

When the message has been read, or in the case of a real-time conversation, when the conversation has ended, the user may simply close the message by double clicking on the face, as shown at 530 in FIG. 10.

FIG. 11 shows some of the devices on which the messaging system may be used. A sender's device is represented at S, and a cloud in which the message may be stored is shown as C. A non-exhaustive list of recipient devices depicted in FIG. 11 includes: a smart watch 540, a smartphone 200, a desktop computing device, such as a Windows PC or Mac, 560, a smart television 570, a vehicle 580 and a virtual reality/immersive device 590. The face message can be sent to or from any enabled smart phone or other device as shown, ie the sender device S need not be a smartphone as shown in the example, but could be any of the other types of device. A real time conversation can be had, or else a message can be played whenever the recipient wishes to view it.

Optionally the user may choose to access the app securely using a facial recognition process for login and/or logout from the app. The app may permit plural user accounts on the same device.

An important aspect of the system is that the face images should be realistic. This requires that the faces be extracted accurately from the background, and substantially in real time. However, the process of selecting the boundary is often not straightforward, not least because of the hair colour, and the variability of the background.

One process for determining the part of the image that corresponds to the hair of the user, will now be described.

This process is preferably performed during recording, by the recording device, substantially in real time by the app.

Firstly the position of the face is determined, using a face recognition algorithm, then the position of the forehead is found. Scanning up the forehead and beyond the system then looks for a colour change, as an edge. At that colour change edge region an assumption is made that the newly found colour is hair colour (C). For a predetermined shape, such as an elliptical region around face, the system then searches for pixels that are close in colour to the assigned “hair” colour. The corresponding colour regions that are short distance from each other are then merged, filling space between these regions with hair colour (C).

This region is then displayed as “hair”. The hair colour is updated and averaged with previous values for subsequent video frames.

The system must check whether the assumed “hair” is in reality part of the background.

To ascertain whether if it is likely that the hair detected using the above process is, in fact, background the system uses the average properties of hair relative to the head.

Where the pattern of region of hair found is not consistent with the expected region on an average face then the hair region should not be displayed or can be faded.

In accordance with a prior art process for face detection, namely iOS, there is a face finding feature (CIDetector). It reports the position of the face but also the eyes and a mouth in an image (featuresInImage:). The face-finding detector does not process frames at full video rate, so only some frames of the video can be processed.

However, in accordance with embodiments of the present invention, the iOS CIDetector reported face features are supplemented with a face tracker that has been trained to extract facial features. This tracker does run at full video rate, or else at least the video rate is slowed down to a rate at which the face tracker can process the video frames to give an estimate of the face position. As part of that estimate the tracker generates three points that are what the tracker estimates to be top of the head. These points are generated for the estimated face angle and the position of the chin points. These need not be particularly accurate but give an indication of where the face is likely to end.

In order to estimate where head hair (not facial hair) might be in a video frame, the position of the forehead is estimate from the three forehead points and two eye points generated by the CIDetector. The means that a forehead estimate can only be made at the slower rate that the CIDetector can process video frames. This region is extended upwards (in this example five times the existing height of the region). For the centre of this region the colour of the image pixels is sampled in a line moving vertically up. Where a strong colour change from the forehead skin (previously sampled to allow skin colour segmentation of the face) is detected this pixel, or the next pixel if the colour change is greater, is selected as the hair colour. Two other lines are scanned up in the same way. One at 45 degrees and another at −45 degrees, so that three separate colour samples are obtained.

The colour samples are averaged over multiple video frames, so that the chance of a single or a few errors will not cause too great a mis-estimation of hair colour. While processing the video frames at full rate the current average hair estimate is used. The estimates of hair colour may not be updated frequently for a number of reasons: a good edge might not be found, the CIDetector may be slow, the CIDetector may not be able to report any features.

In the original video frame, and any other video frames coming after this frame, the hair colour is then used to find pixels that are close to one of the three hair colours. These pixels are further processed by dilatation and erosion operations to expand and merge the hair colour region, then shrink back to the original boundary. This fills in regions of hair that have colours that do not match the sampled colours. This search region is restricted to an ellipse that is larger than the supposed face region.

The region thus defined is used as a template to define the region in the video frame that is hair. This region can be further processed to soften edges if required.

In this embodiment, a simple method is used to detect whether the hair region should be classified as background. A “halo” region is generated from the hair region search ellipse with the face area extracted. The area within this halo region that is classified as hair is compared to the area of the whole halo region. Since it is not expected that a face will have hair in the whole halo area, the ratio of area classified as hair to the total area is used to give an indication of the likelihood that what was detected as hair is actually hair and not background. The ratio that is used will be a matter of judgment, and in this example a smooth step function to allow the hair region and face regions to be mixed according to area ratio. At present the hair region is considered accurate if it is less than 50% of the halo region and not hair if it is more than 62.5% of the halo region. Values in-between these two values lead to mixing of the face and hair region, in proportion to the distance from these edge values, so that there is no sudden discontinuity of hair being added or not.

FIG. 12 shows schematically a system for determining a user reaction to displayed content. A device 1010, which is in this case a tablet, receives content for display from a server 1020. The device displays the content and, at the same time, activates a front-facing camera 1012 which captures an image—preferably a moving image—of the face of a user 1030. The mood of the user can be determined by a processor 1040, which may be located within the device 1010 or else may be located remotely. In addition, the processor may receive other mood indicia from an additional smart device 1050, which data may include any of: heart rate, temperature, blood pressure, perspiration, or any change in these parameters. This information is used to determine the mood of the user and hence to infer the user's reaction to the content sent from the server and displayed on the device 1010.

A report is then sent to a data analysis centre 1060, which may use the data to inform commercial decisions about the content, for example for the content provider.

The device 1010 may extract an image of the face of the user 1030 in accordance with any of the techniques described herein. The processor 1040 may analyze the image and determine the mood of the user by reference to standard, pre-recorded images of the user, or else by use of an algorithm, and/or reference data.

The front-facing camera 1012 may be activated with the knowledge and consent of the user, or else may be activated covertly.

If the device is displaying augmented reality content, for example in accordance with any of the embodiments described herein, both the front and rear facing cameras may be active at the same time.

The processor may be arranged to determine from the facial expression of the user, and/or from the other mood indicia, whether the user's reaction to the content is any of: a positive one, a negative one or indeed neither positive nor negative.

Indeed by monitoring the image of the user's face, and/or capturing one or more of the other response indicia, a user's level of interest or excitement in the content may be determined within an index or range of levels. This need not be a binary value.

FIG. 13 illustrates schematically another embodiment in which a user 2000 interacts with content played on a device 2010 by speaking to the device 2010. In this embodiment, a portion of initial content is displayed on a screen 2012 of the device 2010, preferably in the form of a moving image of a face. The image may be according to any of the examples described above. A cue is provided to the user 2000 that the device is “listening” for the user's query or instructions. The user then indicates that she is about to speak, for example by pressing a button 2014 on the screen.

The user 2000 then speaks naturally to the device 2010 and her speech is picked up by a microphone of the device. The device stores the audio file of the user and the file is transported to a Speech to Text (STT) processing unit 2020 securely via a network N such as the internet. The file is analyzed and an instructional dataset is created and returned to the device 2010. The instruction or query and data set can be stored for analysis and to improve future service.

The dataset is displayed and/or interpreted by the device 2010 to determine additional/further content for the user. The reaction of the user to the content may also be determined using the system described above, as indicated at 2030.

This method of interacting with the user allows content providers to deliver a more personal communication experience than previous systems have provided.

In the above description, the term “virtual image” is intended to refer to a previously captured or separately acquired image—which is preferably a moving image—that is displayed on a display of the device whilst the user views the real, or current, image or images being captured by the camera of the device. The virtual image is itself a real one, from a different reality, that is effectively cut out from that other reality and transplanted into another one—the one that the viewer sees in the display of his device.

When humans interact face to face in the real world, the brain is able to adjust the depth of focus so that background information is automatically discounted, allowing us to concentrate on the face of the other person. However, when we communicate using two-dimensional images displayed on screens, the unwanted background information is received along with the image of the face, and given equal weighting therewith, which can be distracting. In the example given earlier, a face is separated from a background in a recording of a person speaking a message. When playing back the recording it is necessary to distinguish the face from a background in the display device. However, the recording must be suitable for playback on a variety of devices, with differing capabilities.

Turning to FIGS. 14 to 17, there follows a description of a method of encoding a video image such that it can be played back on various types of devices, having varying capabilities.

The transmission between these remote devices may be direct or else may be via a server that can store the video image, and may also have the possibility to process the video.

While it is possible to generate a number of videos in different presentation styles it is more efficient to generate a single format that can be used in multiple devices of different capabilities. This can reduce the overall requirements for communications and storage. Furthermore, this approach also simplifies the generation process, where a single video can be used in perhaps unexpected environments.

In the present application the example given above of an object of interest is a face that may be speaking a message. The preferred presentation style is a video output with a transparent background (FIG. 15). This allows the subject to be displayed in isolation, on top of another image, such as shown in FIG. 1, 5 or 7 for example, or on a live camera feed.

The same application may be required to display the video on another simpler device such as a so-called “smart watch”. This device does not ordinarily allow the display of a transparent moving image on top of other elements, but can display a “normal” video. In this environment a second preference display style can be used. This could be a black background where there would have been transparency. This is in keeping with the smart watch background, which is black (FIG. 17).

Where the same video is to be played on a different, less capable device, for example in the top corner of a television screen, a different style is preferred, without a harsh black (or other colour) background. In this case a version of the video with a blurred background can be played which still highlights the object of interest (the face), as shown in FIG. 16.

In this example, the software OpenGL is used to process images. A face detector and other processing first generate an image that highlights the face. The preferred style of display is with the background removed, but as this might not be possible or desired by the user of the remote device a blurred version of the background is added. This does not impact on the preferred style as the extra data is in a region where the alpha mask would “delete” those pixels.

OpenGL allows for textures with 4 “colours” planes: Red, Green, Blue and Alpha. Alpha attenuates the display and can be used to merge other backgrounds with the image. Most movie formats do not encode the alpha channel and in common smart mobile phones no alpha channel movie formats are supported natively. More importantly no hardware-assisted decoding/encode of alpha capable formats is supported.

The use of an extra “image” encoded to the side of the RGB image for each frame of a movie is a commonly used method of attaching an alpha channel to an RGB-only format movie. This new image is generated by an OpenGL “shader” program with the alpha data to the side of RGB data creating a new

RGB image which can be sent to a movie encoder just as any other RGB image would be processed.

An example of such an image is shown in FIG. 14. A stream of such images is used to generate the movie. The size of the alpha channel image does not need to be the same size as the RGB image. Fewer pixels could be used or they could be encoded differently, for example coding RGB channels separately, so long as the decoding process, which preferably will again use an OpenGL shader, is able to regenerate an alpha plane.

Playback of the “alpha encoded” movie in general requires some kind of extra processing than the usual decoding of a simple RGB video. In the case where a capable device is used for playback the movie would be decoded as normal but then each of the images generated is passed through an

OpenGL shader to generate a new texture from the data with an alpha value for each colour pixel. These alpha values will mask the blurred background and attenuate some of the pixel colours. In this example the attenuation is normally at the edge of the solid colour and acts as “feathering”, so that there is not a harsh outline.

The multi-style video format also allows for the receiving device to give a user the option of a different display style. A different shader can be used to simply display the subject and the blurred background, removing only the alpha mask portion of the video image. Alternatively the black or other colour background might be preferred and again the format allows for this using a different shader.

Device capability can vary, and devices may have the capability to process the video but not display a transparent image. Such a device has the option to process the video images to the style required.

Where a device is limited in its capacity to process the video it can instead request the server where the video is stored to do the processing. In this case the remote device would make a request for the preferred style of video.

Embodiments of the present invention can provide the architecture necessary to perform the role of a graphics processing unit, allowing an otherwise dumb terminal with a camera to record video and upload it for face/hair detection to take place as a post-process operation.

Whilst endeavouring in the foregoing specification to draw attention to those features of the invention believed to be of particular importance, it should be understood that the applicant claims protection in respect of any patentable feature or combination of features referred to herein, and/or shown in the drawings, whether or not particular emphasis has been placed thereon.

1. A messaging system comprising a plurality of devices wherein at least a first sending user device is arranged in use to transmit an image to at least a second receiving user device which image comprises an electronically captured image of at least a part of a head of the sender extracted from a background.

2. A system according to claim 1, wherein the image is arranged to be sent via a communications network including a processor-based server.

3. A system according to claim 1, wherein the system is arranged in use to extract an image of at least a part of a head, and more preferably at least a part of a face, from a background.

4. A system according to claim 1, wherein the system is arranged in use to send a first moving image from a first sender to a first receiver and to send a second moving image from a second sender to a second receiver.

5. A system according claim 1, wherein the system is arranged in use to provide an augmented reality image, the system comprising a camera for recording a basic image comprising a subject and a first background using a recording device, an image processor for extracting a subject image from the basic image, and a display device for combining the extracted subject image with a second background, wherein the subject image comprises at least a part of a head.

6. A system according to claim 5, wherein the extracted subject image is arranged in use to be combined with the second background as imaged by a camera of the display device.

7. A system according to claim 5, wherein the processor is arranged in use to extract the subject from the basic image locally with respect to the recording device, within the device.

8. A system according to claim 5, wherein the processor is arranged in use to extract the subject image from the basic image remotely from the recording device.

9. A system according to claim 5, wherein the processor is arranged in use to extract the subject image from the basic image in real time, with respect to the recording of the basic image.

10. A system according to claim 5, wherein the processor is arranged in use to extract the subject image from the basic image after the recording of the basic image.

11. A method of messaging between a plurality of devices, wherein at least a first, sending user is arranged in use to transmit an image to at least a second, receiving user which image comprises an electronically captured image of at least a part of a head of the sender extracted from a background.

12. A method according to claim 11, wherein the method comprises extracting an image of at least a part of a head, including at least a part of a face, from a background.

13. A method according to claim 11, wherein the image comprises a moving video image.

14. A method according to claim 11, wherein the method comprises sending a first moving image from a first sender to a first receiver and sending a second moving image from a second sender to a second receiver.

15. A method according to claim 11, wherein the method includes providing an augmented reality image, by recording a basic image comprising at least a part of a head and a first background using a recording device, extracting a subject image comprising the at least part of the head from the basic image, and providing the extracted subject image to a display device for combining with a second background.

16. A method according to claim 15, wherein the second background comprises any of, but not limited to: a desktop background, e.g. a display screen of a device, a background provided by an application or a background captured by a camera.

17. A method according to claim 15, wherein the background is captured by a camera of a device on which the subject image is to be viewed.

18. A method according to claim 15, wherein the extracted subject image is provided to the display device for combining with a second background as imaged by a camera of the display device.

19. A method according to claim 15, wherein the step of extracting the subject from the basic image is performed locally within the device.

20. A method according to claim 15, wherein the step of extracting the subject image from the basic image is performed remotely from the recording device.

21. A method according to claim 15, wherein the step of extracting the subject image from the basic image is performed in real time, with respect to the recording of the basic image.

22. A method according to claim 15, wherein the step of extracting the subject image from the basic image is performed after recording of the basic image.

23. A method according to claim 15, wherein the method comprises recording a basic image comprising a subject and a first background, extracting a subject from the background as a subject image, sending the subject image to a remote device and combining the subject image with a second background at the remote device.

24. A method according to claim 23, wherein the method includes extracting a subject from a basic image by using one or more of the following processes: subject feature detection, subject colour modelling and subject shape detection.

25. An apparatus for automatically determining the perimeter of a face or head with hair in an electronically captured image, the apparatus comprising a facial detection unit and a perimeter detection unit, wherein in use the facial detection unit is arranged to detect a face, and the perimeter detection unit is arranged to determine a forehead, based upon the position of recognised facial features, and then to identify an edge region on the forehead, indicative of hair, based upon a colour change.

26. An apparatus according to claim 25, wherein the perimeter detection unit is arranged to assign a hair colour based upon the pixel colour beyond the edge region.

27. An apparatus according to claim 26, wherein the perimeter detection unit is arranged in use to determine an area around the face and search for regions within the area that have a colour value within a predetermined threshold range of the colour.

28. A method of automatically determining the perimeter of a face with hair in an electronically captured image, the method comprising detecting a face, determining a forehead, based upon the position of recognised facial features and identifying an edge region on the forehead, indicative of hair, based upon a colour change.

29. A method according to claim 28, wherein the method comprises assigning a hair colour based upon the pixel colour beyond the edge region.

30. A method according to claim 29, wherein the method comprises determining an area around the face and searching for regions within the area that have a colour value within a predetermined threshold of the colour.

31. An apparatus for determining a user reaction to media content delivered to the user on a device comprising a camera, the apparatus being arranged in use to play the content and to monitor an image of the user's face, wherein a processor is arranged to determine the user's reaction to the content by analysis of the image.

32. An apparatus according to claim 31, wherein the image is a moving image.

33. An apparatus according to claim 31, wherein the processor is arranged to compare the image with one or more stored reference images.

34. An apparatus according to claim 31, wherein the apparatus is arranged to determine whether the user has a positive reaction to the content, a negative reaction to the content and/or a reaction to the content that is neither positive nor negative.

35. An apparatus according to claim 31, wherein the image comprises an image of the face of the user extracted from a background.

36. An apparatus according to claim 31, wherein the apparatus is arranged to monitor other response indicia from the user, including one or more of (but not limited to): temperature change, heart rate/pulse, perspiration level change, blood-pressure change and pupil dilation.

37. A method of determining a user reaction to media content delivered to the user on a device including a camera, the method comprising playing the content on the device, enabling a camera of the device to capture an image of the user's face and analysing the image to determine the user's reaction to the content.

38. An apparatus for user interaction with content delivered to the user on a device comprising a display, wherein the apparatus is arranged in use to play a first portion of content on the display and to capture an instruction and/or a reaction from the user, wherein a processor is arranged to select and play at least a subsequent portion of content on the display based upon the instruction and/or reaction from the user.

39. A method of interacting with media content delivered to a user, the method comprising providing at least a first portion of content on a display of a user's device, capturing audio and/or visual instruction and/or reaction from a user in response to the content, and selecting further content for display to the user based upon the captured instruction, from a library of further content items.

40. A method of encoding a video image, the method comprising recording a video image comprising a subject portion and a background portion, detecting the subject portion and extracting it from the background portion, generating a mask corresponding to the outline of the subject portion, and ascribing a first alpha value to the region within the outline and a second alpha value to the region outside the outline, the method further comprising pairing frames of the video image in which one of the pair comprises the subject against a background that is blurred, and the other of the pair comprises the mask.

41. A video encoding device, arranged in use to record a video image comprising a subject portion and a background portion, detect the subject portion and extract it from the background portion, generate a mask corresponding to the outline of the subject portion, and ascribe a first alpha value to the region within the outline and a second alpha value to the region outside the outline, wherein the device is further arranged in use to pair frames of the video image in which one of the pair comprises the subject against a background that is blurred, and the other of the pair comprises the mask.

42. A method according to claim 40, wherein the first alpha value is significantly larger than the second alpha value, so that the region of the mask outside the outline appears as a dark, more preferably black, background.

43. A program for causing a device to perform a method according to claim 11.

44. A computer program product, storing, carrying or transmitting thereon or therethrough a program for causing a device to perform a method according to claim 11.
